(19) United States
(12) Patent Application Publication
(10) Pub. No.: US 2009/0207228 A1
(43) Pub. Date: Aug. 20, 2009

(54) METHOD OF FORMING IMAGE BY THERMAL TRANSFER

(75) Inventors: Hidekazu SAKAI, Minami-ashigara-shi (JP); Shinichi TERAMAE, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/368,877

(22) Filed: Feb. 10, 2009

(30) Foreign Application Priority Data
Feb. 13, 2008 (JP) 2008-032477

(51) Int. Cl. B41J 2/335

(52) U.S. Cl. 347/200

(57) ABSTRACT

A method of forming an image, including the steps of superposing a heat-sensitive transfer sheet on a heat-sensitive transfer image-receiving sheet, and applying thermal energy from a side of a heat-resistant lubricating layer of the heat-sensitive transfer sheet, to transfer a thermally transferable dye in a thermal transfer layer to a receptor layer, thereby forming a thermally transferred image. The heat-sensitive transfer sheet and the heat-sensitive transfer image-receiving sheets, including constituent layers and components thereof, are as described herein.

### FIELD OF THE INVENTION

The present invention relates to a method of forming an image by thermal transfer by using a heat-sensitive transfer sheet and a heat-sensitive transfer image-receiving sheet. In particular, the present invention relates to an image-forming method by thermal transfer, giving images without any image defect and improved in storability under various environmental conditions, i.e., under a high-temperature high-humidity condition or a low-temperature low-humidity condition.

### BACKGROUND OF THE INVENTION

Various heat transfer recording methods have been known so far. Among these methods, dye diffusion transfer recording systems attract attention as a process that can produce a color hard copy having an image quality closest to that of silver halide photography. Moreover, this system has advantages over silver halide photography: it enables direct visualization from digital data; it makes reproduction simple, and the like without treatment chemicals.

In this dye diffusion transfer recording system, a heat-sensitive transfer sheet (hereinafter also referred to as an ink sheet) containing dyes is superposed on a heat-sensitive transfer image-receiving sheet (hereinafter also referred to as an image-receiving sheet), and then the ink sheet is heated by a thermal head whose exothermic action is controlled by electric signals, in order to transfer the dyes contained in the ink sheet to the image-receiving sheet, thereby recording an image information. Three colors: cyan, magenta, and yellow, are used for recording a color image by overlapping one color to other, thereby enabling transferring and recording a color image having continuous gradation for color densities.

In recent years, because an acceleration of a printer can shorten user's waiting time in the case where print is conducted in a photo shop for user's advantage, high-speed printers in the sublimation-type thermal transfer recording system, which can provide a print in a short time, have been developed and commercialized one after another.

In wide spread use of the printers in the sublimation-type thermal transfer recording system, there is a demand for a printer providing prints at good image quality under various environmental conditions without depending on an installation site. That is, in order to satisfy user's needs, it is necessary to provide a print good in image quality and free from image defect, not only under the standard air-conditioned environmental condition of offices and shops at a temperature of 23° C. to 27° C. and a humidity of 50% to 70%, but also, for example; under a high-temperature high-humidity condition in summer (e.g., temperature: 35° C., humidity: 80%) and a low-temperature low-humidity condition in winter (e.g., temperature: 10° C., humidity: 20%).

A technical problem of sublimation-type thermal transfer process is limited storability of the heat-sensitive transfer sheets. The heat-sensitive transfer sheets used in the sublimation-type thermal transfer process are normally those having a substrate for example of polyethylene terephthalate and a transfer layer formed thereon that contains low-molecular weight dye that is compatibilized with a binder polymer compound as it is dispersed therein. The binder for use in the transfer layer should have two contradictory properties. Specifically when the transfer efficiency is considered, the binder should be less compatible with the dye molecule for more efficient liberation of the dye molecule. On the other hand, when the storability is considered, the compatibility with the dye molecule should be higher for prevention of aggregation or precipitation of the dye molecules.

To solve the problem specifically, proposed were methods of using polyvinylacetals having a particular structure as the binder (see, for example, JP-A-63-151484 (“JP-A” means unexamined published Japanese patent application), JP-A-4-23605), but these documents do not mention the failures caused by separation defects described below.

Another technical problem of the sublimation-type thermal transfer process is image failure due to separation defects between the heat-sensitive transfer sheet and the heat-sensitive transfer image-receiving sheet. As described above in the sublimation-type thermal transfer process, a heat-sensitive transfer sheet and a heat-sensitive transfer image-receiving sheet are laminated to form an image. After the image is formed on the heat-sensitive transfer image-receiving sheet, the heat-sensitive transfer sheet which is now unneeded should be separated without leaving any undesired matter on the heat-sensitive transfer image-receiving sheet. However, need for reduction of the printing period is leading to heightening of the temperature applied to the heat-sensitive transfer sheet during recording (and resulting reduction of heating time). For that reason, there was increased possibility of image failures such as fusion of the heat-sensitive transfer sheet or insufficient continuous separation between the heat-sensitive transfer sheet and the heat-sensitive transfer image-receiving sheet, leaving residual separation streaks after printing.

For prevention of fusion between the heat-sensitive transfer sheet and the heat-sensitive transfer image-receiving sheet, proposed were methods of using a releasing agent such as a silicon or fluorine compound. As one of the methods proposed was a method of introducing such a releasing agent in the image-receiving sheet, but a transparent resin film is often laminated on the heat-sensitive transfer image-receiving sheet after image formation in recent sublimation-type thermal transfer recording methods for improvement in the abrasion resistance and the light fastness of the formed image. Presence of a releasing agent in the heat-sensitive transfer image-receiving sheet then may become disadvantageous in laminating a transparent resin film.

Another method proposed is a method of introducing a releasing agent into the heat-sensitive transfer sheet. Problems of these methods are deterioration in density of transferred image and also in storability as described above. In particular when a ribbon after storage for an extended period of time is used, there is observed a serious problem of the phenomenon that the dye is transferred onto the heat-sensitive transfer image-receiving sheet, consequently contaminating the white area thereof, independently of whether the heat-sensitive transfer sheet is heated or not. Methods of introducing a silicon or fluorine compound having a particular structure as the releasing agent into the heat-sensitive transfer sheet was proposed for that purpose (see e.g., JP-A-4-113889 and JP-B-3150691 (“JP-B” means examined Japanese patent publication)), but the storability-improving effect was still insufficient. In addition, these methods, even in combination with the methods proposed in JP-A-63-151484 and JP-A-4-23605 described above, were still not satisfactory in the storability-improving efficiency.

Recently, those have been proposed heat-sensitive transfer image-receiving sheets in which a receptor layer contains a water soluble polymer compound and a latex that is an aqueous dispersion of a resin. That these image-receiving sheets provide excellent print properties including a proper sensitivity and absence of white spot (white spot by printing-failure in the solid image) is disclosed (see, e.g., JP-A-8-2123 and JP-A-2006-88691).

However, although these heat-sensitive transfer image-receiving sheets give preferable image quality under standard conditions (e.g., a temperature of 25° C. and a humidity of 60%), they cause image failures due to separation defects under high-temperature high-humidity conditions (e.g., temperature 35° C., humidity 80%) and are thus in sufficient in satisfying the user need. Thus, if such a kind of heat-sensitive transfer image-receiving sheet is used, the heat-sensitive transfer sheet should have sufficiently preferable releasing property.

### SUMMARY OF THE INVENTION

The present invention resides in a method of forming an image, comprising the steps of:

superposing a heat-sensitive transfer sheet on a heat-sensitive transfer image-receiving sheet, and

applying thermal energy from a side of a heat-resistant lubricating layer described below of the heat-sensitive transfer sheet, to transfer a thermally transferable dye in a thermal transfer layer to a receptor layer described below, thereby forming a thermally transferred image,

wherein the heat-sensitive transfer sheet comprises a substrate, the thermal transfer layer containing the thermally transferable dye and a resin on one face of the substrate, and the heat-resistant lubricating layer on the other face of the substrate,
wherein the heat-sensitive transfer image-receiving sheet comprise a support, and at least one heat insulation layer and at least one receptor layer on the support in this order,
wherein the dye in the thermal transfer layer is present in an oil soluble resin having a glass transition temperature (Tg) of 98° C. or more as it is dispersed in the resin,
wherein the thermal transfer layer contains a polymer compound having fluorine atom-substituted aliphatic groups on its side chains, and
wherein the receptor layer of the heat-sensitive transfer image-receiving sheet contains a latex and a water-soluble polymer compound.

Other and further features and advantages of the invention will appear more fully from the following description, appropriately referring to the accompanying drawings.

### BRIEF DESCRIPTION OF THE DRAWINGS

FIGS. 1A and 1B are schematic views illustrating structures of silicone polymers.

### DETAILED DESCRIPTION OF THE INVENTION

According to the present invention, there is provided the following means.

Specifically, the inventors have found that it was possible to improve the storability and prevent the image failures caused by separation defects even under various environmental conditions by the following means:

(1) A method of forming an image, comprising the steps of:

superposing a heat-sensitive transfer sheet on a heat-sensitive transfer image-receiving sheet, and

applying thermal energy from a side of a heat-resistant lubricating layer described below of the heat-sensitive transfer sheet, to transfer a thermally transferable dye in a thermal transfer layer to a receptor layer described below, thereby forming a thermally transferred image,

wherein the heat-sensitive transfer sheet comprises a substrate, the thermal transfer layer containing the thermally transferable dye and a resin on one face of the substrate, and the heat-resistant lubricating layer on the other face of the substrate,
wherein the heat-sensitive transfer image-receiving sheet comprise a support, and at least one heat insulation layer and at least one receptor layer on the support in this order,
wherein the dye in the thermal transfer layer is present in an oil soluble resin having a glass transition temperature (Tg) of 98° C. or more as it is dispersed in the resin,
wherein the thermal transfer layer contains a polymer compound having fluorine atom-substituted aliphatic groups on its side chains, and
wherein the receptor layer of the heat-sensitive transfer image-receiving sheet contains a latex and a water-soluble polymer compound.

(2) The method of forming an image described in (1), wherein the resin in the thermal transfer layer is a polyvinylacetal resin containing acetal units in an amount of 80 mass % or more in the resin and the acetacetal rate is 90 mass % or more in the acetal unit.

(3) The method of forming an image described in (1) or (2), comprising: using a heat-sensitive transfer sheet, wherein the ratio of the dye in the thermal transfer layer is 1 or more by weight in the resin.

(4) The method of forming an image described in any one of (1) to (3), wherein the heat-sensitive transfer sheet contains at least one compound selected from the silicone graft polymers and silicone block polymers.

(5) The method of forming an image described in any one of (1) to (4), wherein the resin in the thermal transfer layer is hardened with a crosslinking agent.

The method of forming an image of the present invention is explained in detail below.

First, the heat-sensitive transfer sheet for use in the present invention is explained in detail below.

The heat-sensitive transfer sheet has a substrate and a thermal transfer layer containing a diffusion transfer dye (hereinafter, referred to as thermal transfer layer or dye layer) formed thereon, and preferably has an additional transfer protective-layer laminate, for forming a protective layer of a transparent resin on the thermally transferred image and thus covering and protecting the image formed on the same substrate.

In the heat-sensitive transfer sheet, preferably, thermal transfer layers in individual colors of yellow, magenta and cyan, and an optional thermal transfer layer in black are repeatedly provided onto a single substrate in area order in such a manner that the colors are divided from each other. An example of the thermal transfer layers is an embodiment wherein thermal transfer layers in individual colors of yellow, magenta and cyan are provided onto a single substrate in the longitudinal direction of the substrate in area order, correspondingly to the area of the recording surface of the above-mentioned heat-sensitive transfer image-receiving sheet, in such a manner that the colors are divided from each other. In addition to the three layers above, it may have a black thermal transfer layer. In addition, the heat-sensitive transfer sheet preferably has a mark indicating the start point of each of various colors allowing recognition by the printer used.

In the heat-sensitive transfer sheet, dyes in various hues are applied on a substrate, as they are dispersed in a binder. The binder for use in the heat-sensitive transfer sheet according to the present invention is not particularly limited, if it is a binder having a glass transition temperature (Tg) of 98° C. or higher, and various known binders are usable. The glass transition temperature (Tg) is a temperature observed, for example, in polymer compounds that is associated with change in physical properties. Generally, heating of a polymer substance leads to conversion from a glass-like solid state to a rubbery soft state. The phenomenon is called glass transition, and the glass transition temperature (Tg) is defined as the temperature at which the glass transition occurs. There are various methods of determining the glass transition temperature, but in the present invention, the glass transition temperature, as determined by the differential thermal analysis (DSC) method described in JIS K7121-1987, is used.

The glass transition temperature of the binder used in the heat-sensitive transfer sheet according to the present invention should be 98° C. or higher, preferable in the range of 98° C. or higher and 150° C. or lower, more preferably in the range of 100° C. or higher and 140° C. or lower, and more preferably in the range of 105° C. or higher and 125° C. or lower.

Examples of a polymer compound as a binder used in the heat-sensitive transfer sheet according to the present invention include acrylic resins such as polyacrylonitrile, polyacrylate, and polyacrylamide; polyvinyl acetal resins such as polyvinyl acetacetal, and polyvinyl butyral; cellulose resins such as ethylcellulose, hydroxyethylcellulose, ethylhydroxycellulose, hydroxypropylcellulose, ethylhydroxyethylcellulose, methylcellulose, cellulose acetate, cellulose acetate butyrate, cellulose acetate propionate, cellulose nitrate, other modified cellulose resins, nitrocellulose, and ethylhydroxyethylcellulose; other resins such as polyurethane resin, polyamide resin, polyester resin, polycarbonate resin, phenoxy resin, phenol resin, and epoxy resin; and various elastomers.

These may be used alone, or two or more thereof may be used in the form of a mixture or copolymer.

The binder according to the present invention is preferably a polyvinylacetal resin, more preferably a polyvinyl acetacetal resin. The polyvinyl acetacetal resin according to the present invention preferably has a composition having the acetal units in an amount of 80 mass % or more in the resin and a acetacetal rate of 90 mass % or more in the acetal unit, more preferably a composition having the acetal units in an amount of 80 mass % or more and an acetacetal rate in the acetal unit of 95 mass % or more, and most preferably a composition having the acetal units in an amount of 80 mass % or more and an acetacetal rate in the acetal unit of 99 mass % or more. The acetal unit may contain acetacetal and other acetal groups (such as butyral) within the technical scope of the present invention.

The acetal resins can be prepared by the methods described in JP-B-3065111 and the documents cited therein, and there are also commercially available products such as Eslex KS-5 (trade name, Tg: 110° C., manufactured by Sekisui Chemical Co., Ltd.), DENKA BUTYRAL #5000-D (trade name, Tg: 110° C., manufactured by Denki Kagaku Kogyo K.K.) and others.

In a preferable embodiment of the present invention, the binder in the heat-sensitive transfer sheet according to the present invention is crosslinked with various crosslinking agents.

The crosslinking agent is a compound reactive with the functional groups on the main and side chains of a polymer compound, connecting the polymers to each other. Because the polyvinylacetal resin favorably used as the binder in the heat-sensitive transfer sheet according to the present invention preferably has active-hydrogen hydroxyl groups in the main chain, isocyanate compounds having multiple isocyanate groups (—N═C—O) therein are used favorably as the crosslinking agents. Hereinafter, typical examples of the isocyanates will be described.

### (1) Diisocyanate Compounds

Examples of aromatic polyisocyanates include tolylene diisocyanate, diphenylmethane diisocyanate, tolidine diisocyanate, and naphthalene diisocyanate, and examples of aliphatic polyisocyanates include hexamethylene diisocyanate, isophorone diisocyanate, xylelyn diisocyanate, hydrogenated xylelyn diisocyanate, and dicyclohexylmethane diisocyanate.

### (2) Triisocyanate Compound

Examples of triisocyanate compound include trimethylolpropane-modified tolylene diisocyanates, isocyanurate-bound tolylene diisocyanates, trimethylolpropane-modified hexamethylene diisocyanates, isocyanurate-bound hexamethylene diisocyanates, buret-bound hexamethylene diisocyanates, trimethylol isophorone diisocyanate, isocyanurate-bound isophorone diisocyanate, triphenylmethane triisocyanate, and tris(isocyanatophenyl)thiophosphate.

Alternatively, use of a mixture of these isocyanate compounds or a polymer containing the isocyanate compounds on the main or side chains is also preferable.

These isocyanates are commercially available, for example, under the trade names of Burnock (Dainippon Ink and Chemicals, Inc.), Takenate and MT-Olester (both, prepared by Mitsui Chemicals Polyurethane Inc.), and Coronate (Nippon Polyurethane Industry).

As for the use amount of the isocyanates, the molar ratio (NCO/H) of the isocyanate groups (NCO) to the binder active hydrogen atoms (H) is preferably in the range of 0.2 to 2.0, more preferably in the range of 0.3 to 1.5.

A catalyst may be added for the purpose of accelerating the crosslinking reaction between the binder and the isocyanate. Such catalysts are described in “Current Polyurethane Materials and Application Technologies” (CMC Publishing, 2005).

The heat-sensitive transfer sheet for use in the image-forming method according to the present invention contains a polymer compound having fluorine atom-substituted aliphatic groups on the side chains in the heat-sensitive transfer layer. The polymer compound having fluorine atom-substituted aliphatic groups on its side chains can be derived from a fluoro aliphatic compound (compound having a fluorine atom-substituted aliphatic group(s) on the side chain(s)) produced by a telomerization method (also referred to as a telomer method), or an oligomerization method (also referred to as an oligomer method). The fluoro aliphatic compound can be easily synthesized by, for example, a method described in JP-A-2002-90991.

The fluorine atom-substituted aliphatic group is an aliphatic group (straight-chain, branched or cyclic aliphatic group), preferably an alkyl, alkenyl or cycloalkynyl group having 1 to 36 carbon atoms, having at least one substituted fluorine atom, more preferably an alkyl group having 1 to 36 carbon atoms (preferably 1 to 18 carbon atoms, more preferably 1 to 12 carbon atoms, furthermore preferably 1 to 10 carbon atoms, most preferably 4 to 8 carbon atoms) having at least one substituted fluorine atom. The aliphatic group may be substituted additionally with a substituent other than the fluorine atom. Examples of the substituent include alkyl groups, aryl groups, heterocyclic groups, halogen atoms other than the fluorine atom, a hydroxyl group, alkoxy groups, aryloxy groups, alkylthio groups, arylthio groups, an amino group, alkylamino groups, arylamino groups, heterocyclic amino groups, acylamino groups, sulfone amino groups, carbamoyl groups, sulfamoyl groups, a cyano group, a nitro group, acyl groups, sulfonyl groups, ureido groups, and urethane groups.

In the present invention, the fluorine atom-substituted aliphatic group is most preferably a perfluoroalkyl group.

The polymer compound having fluorine atom-substituted aliphatic group(s) on the side chains is preferably a polymer or copolymer of a fluorine atom-substituted aliphatic group-containing monomer, and examples of the monomer include acrylic acid derivatives (e.g., acrylic acids, acrylic esters, and acrylamides, preferably acrylic esters and acrylamides, more preferably acrylic esters) and methacrylic acid derivatives (e.g., methacrylic acids, methacrylic esters, and methacrylamides, preferably methacrylic esters and methacrylamides, more preferably methacrylic esters) each having an acyl moiety, alcohol moiety or amide moiety (a substituent bonding with the nitrogen atom) substituted with a fluorine atom-substituted aliphatic group; and acrylonitrile derivatives having a fluorine atom-substituted aliphatic group.

In the case where the polymer compound having fluorine atom-substituted aliphatic groups on the side chains is a copolymer with a fluorine atom-substituted aliphatic group-containing monomer, examples of the monomer used in combination include acrylates, methacrylates, acrylonitriles, acrylamides, methacrylamides, olefins, and styrenes. Among these, acrylates, methacrylates, acrylonitriles, acrylamides, and methacrylamides are preferable; acrylates and methacrylates are more preferable; and among them, those having a polyoxyalkylene (e.g., polyoxyethylene, polyoxypropylene) unit in the group substituted on the alcohol group or the amide nitrogen atom are preferable.

In the present invention, the polymer above is preferably a copolymer, which may be a binary copolymer or a ternary or higher copolymer.

As the polymers having a fluoro aliphatic group on its side chains, preferred are copolymers of a monomer having an aliphatic group substituted with a fluorine atom and poly(oxyalkylene)acrylate and/or poly(oxyalkylene)methacrylate. They may be random copolymers or block copolymers. Examples of the poly(oxyalkylene) group include poly(oxyethylene) group, poly(oxypropylene) group, and poly(oxybutylene) group. Further, the poly(oxyalkylene) group may be a unit having alkylene groups of chain lengths different from each other in the same chain, such as poly(block connecter of oxyethylene and oxypropylene and oxyethylene) and poly(block connecter of oxyethylene and oxypropylene). Further, the copolymer of a monomer having an aliphatic group substituted with a fluorine atom and poly(oxyalkylene)acrylate (or methacrylate) is not limited to binary copolymers, but may be ternary or more multiple copolymers that can be produced by copolymerizing several different co-monomers such as monomers having two or more different aliphatic groups substituted with a fluorine atom and two or more different kinds of poly(oxyalkylene)acrylate (or methacrylate).

A weight-average molecular weight of the polymers having an aliphatic group substituted with a fluorine atom on its side chains ranges preferably from 5,000 to 100,000, more preferably from 8,000 to 50,000, and further preferably from 10,000 to 40,000.

Examples of the copolymers include copolymers of acrylate (or methacrylate) having a perfluorobutyl group (—C₄F₉) and poly(oxyalkylene)acrylate (or methacrylate); copolymers of acrylate (or methacrylate) having a perfluorobutyl group, poly(oxyethylene)acrylate (or methacrylate) and poly(oxypropylene)acrylate (or methacrylate); copolymers of acrylate (or methacrylate) having a perfluorohexyl group (—C₆F₁₃) and poly(oxyalkylene)acrylate (or methacrylate); copolymers of acrylate (or methacrylate) having a perfluorohexyl group, poly(oxyethylene)acrylate (or methacrylate) and poly(oxypropylene)acrylate (or methacrylate); copolymers of acrylate (or methacrylate) having a perfluorooctyl group (—C₈F₁₇) and poly(oxyalkylene)acrylate (or methacrylate); and copolymers of acrylate (or methacrylate) having a perfluorooctyl group, poly(oxyethylene)acrylate (or methacrylate) and poly(oxypropylene)acrylate (or methacrylate).

Further, the polymers having an aliphatic group substituted with a fluorine atom at a side chain are commercially available as a general name such as “perfluoroalkyl-containing oligomers”. For example, the following products can be used.

As the products of Dainippon Ink & Chemicals Incorporated, there are Megafac F-470, Megafac F-471, Megafac F-472SF, Megafac F-474, Megafac F-475, Megafac F-477, Megafac F-478, Megafac F-479, Megafac F-480SF, Megafac F-472, Megafac F-483, Megafac F-484, Megafac F-486, Megafac F-487, Megafac F-489, Megafac F-172D, Megafac F-178K, Megafac F-178RM (each trade name). As the products of Sumitomo 3 M Limited, there are Novec™ FC-4430 and FC-4432 (each trade name).

The polymer compound having aliphatic groups substituted with a fluorine atom on its side chains is preferably a nonionic compound (having no dissociable group in water such as sulfo group and carboxyl group), and more preferably water-soluble to a certain degree. The phrase “water soluble to a certain degree” means that the polymer compound has solubility in pure water of 1% or more at 25° C. Specifically, the polymer is, for example, a polymer compound having a hydroxyl group(s) and/or the oxyalkylene group(s) described above. Favorable examples thereof include water-soluble compounds such as Megafac F-470, Megafac F-472SF, Megafac F-477, Megafac F-479, Megafac F-480SF, Megafac F-484, and Megafac F-486 (all trade names, manufactured by Dainippon Ink & Chemicals Incorporated).

In the present invention, the reason why the polymer compound having fluorine atom-substituted aliphatic groups on its side chains is preferably nonionic and soluble in water to a certain degree is not yet to be understood, but is assumed as follows.

The nonionic polymer compound having fluorine atom-substituted aliphatic groups on its side chains is suitably compatible with the dye and the binder in the thermal transfer layer and present stably in the layer during storage of the heat-sensitive transfer sheet. Thus, it is unlikely to cause troubles such as acceleration of dye bleeding out. On the other hand, the polymer compound, which is suitably compatible, because of its water solubility, with the receptor layer of the heat-sensitive transfer image-receiving sheet having a latex, seems to emanate into the interface between the heat-sensitive transfer sheet and the heat-sensitive transfer image-receiving sheet during image-formation under a high-temperature high-humidity condition, where it shows its releasing action effectively.

The polymer compound having fluorine atom-substituted aliphatic groups on its side chains may be added to any one of the thermal transfer layers in yellow, magenta, cyan, and black as needed, and may be contained in a single thermal transfer layer or in multiple thermal transfer layers. It is preferably added to all of the yellow, magenta and cyan thermal transfer layers.

The addition amount of the polymer compound having fluorine atom-substituted aliphatic groups on its side chains may be determined properly according to the kinds and amounts of the dye and the binder used, but the amount is preferably 0.01% to 20%, more preferably, 0.1% to 10%, and still more preferably 0.2% to 5%, with respect to the total solid content (mass) in the thermal transfer layer.

In the present invention, the thermal transfer layer generally contains a sublimation type dye and a binder. The thermal transfer layer may further contain waxes, silicone resins, and polymer particles and inorganic particles, in accordance with necessity.

Each dye in the dye layer is preferably contained in an amount of 20 to 80 mass % of the dye layer, preferably in that of 30 to 70 mass % thereof.

The coating of the dye layer (i.e., the painting of a coating solution for the dye layer) is performed by an ordinary method such as roll coating, bar coating, gravure coating, or gravure reverse coating. The coating amount of the dye layer is preferably from 0.1 to 2.0 g/m², more preferably from 0.2 to 1.2 g/m² (the amount is a numerical value converted to the solid content in the layer; any coating amount in the following description is a numerical value converted to the solid content unless otherwise specified). The film thickness of the dye layer is preferably from 0.1 to 2.0 μm, more preferably from 0.2 to 1.2 μm.

The dyes contained in the dye layer in the present invention must be the dyes are able to diffuse by heat and able to be incorporated in a heat-sensitive transfer sheet, and able to transfer by heat from the heat-sensitive transfer sheet to an image-receiving sheet. As the dyes that are used for the heat-sensitive transfer sheet, ordinarily used dyes or known dyes can be effectively used.

Preferable examples of the dyes that is used in the present invention include diarylmethane-series dyes, triarylmethane-series dyes, thiazole-series dyes, methine-series dyes such as merocyanine; azomethine-series dyes typically exemplified by indoaniline, acetophenoneazomethine, pyrazoloazomethine, imidazole azomethine, imidazo azomethine, and pyridone azomethine; xanthene-series dyes; oxazine-series dyes; cyanomethylene-series dyes typically exemplified by dicyanostyrene, and tricyanostyrene; thiazine-series dyes; azine-series dyes; acridine-series dyes; benzene azo-series dyes; azo-series dyes such as pyridone azo, thiophene azo, isothiazole azo, pyrrol azo, pyralazo, imidazole azo, thiadiazole azo, triazole azo, and disazo; spiropyran-series dyes; indolinospiropyran-series dyes; fluoran-series dyes; rhodaminelactam-series dyes; naphthoquinone-series dyes; anthraquinone-series dyes; and quinophthalon-series dyes.

Specific examples of the yellow dyes include Disperse Yellow 231, Disperse Yellow 201 and Solvent Yellow 93. Specific examples of the magenta dyes include Disperse Violet 26, Disperse Red 60, and Solvent Red 19. Specific examples of the cyan dyes include Solvent Blue 63, Solvent Blue 36, Disperse Blue 354 and Disperse Blue 35. As a matter of course, it is also possible to use suitable dyes other than these dyes as exemplified above.

Further, dyes each having a different hue from each other as described above may be arbitrarily combined together.

Each of the heat transfer layers may have a mono-layered structure or a multi-layered structure. In the case of the multi-layered structure, the individual layers constituting the heat transfer layer may be the same or different in composition.

Hereinafter, the silicone compound favorably used in the heat-sensitive transfer sheet according to the present invention will be described.

Combined use of a silicone compound in the heat-sensitive transfer sheet according to the present invention is also preferable. The silicone compound according to the present invention is a compound having polysiloxane structures containing SiO as the recurring unit on the main and side chains in the molecule. Typical examples thereof include silicone oils having hydrogen atoms, alkyl groups or aryl groups bound to the Si atoms in the polymer main chain containing SiO as the recurring unit. Hereinafter, the polysiloxane herein represents a structure having SiO as recurring unit and carrying on the Si atoms hydrogen atoms, substituted or unsubstituted alkyl groups, or substituted or unsubstituted aryl groups, like the silicone oil described above.

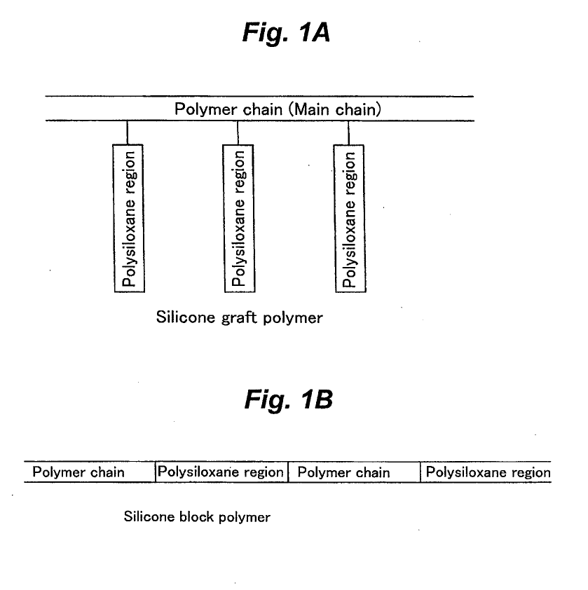

The silicone compound favorably used in the present invention is a silicone graft polymer or a silicone block polymer. The silicone graft polymer is a polymer having structure carrying multiple branched side-chains in the polysiloxane structure bound to each main chain of the polymer. The silicone block polymer is a polymer having a structure having polysiloxane structures embedded in the polymer main chains. The structures are shown in FIGS. 1A and 1B. FIG. 1A shows the schematic structure of a silicone graft polymer, while FIG. 1B shows the schematic structure of a silicone block polymer.

The main chain of the silicone graft polymer may be a polymer of a single monomer or a copolymer of multiple kinds of monomers. Alternatively, it may have a block polymer structure in which multiple polymer segments are bound to each other. In addition, the side chain may have only a polysiloxane structure or a structure in combination with other structures. The side chain polysiloxane region may be made of a single polysiloxane unit or in combination of multiple different kinds of polysiloxane units. The average content of the polysiloxane units in the polymer is preferably in the range of 5 mass % or more and 70 mass % or less, more preferably in the range of 10 mass % or more and 50 mass % or less.

The polymer chain region shown in FIG. 1B in the silicone block polymer may be a polymer of a single monomer or a copolymer of multiple kinds of monomers. The polymer chain region may be made of multiple different kinds of polymer chains. Similarly to the polymer chain, the polysiloxane region can be made of multiple different kinds of polysiloxane units. Both the polymer chain and the polysiloxane region may have a so-called graft polymer structure having side-chains. The average content of the polysiloxane units in the polymer is preferably in the range of 5 mass % or more and 70 mass % or less, more preferably in the range of 10 mass % or more and 50 mass % or less.

Such a polymer can be produced by various methods. For example, known are methods of forming a polymer chain having suitable functional groups as the main chain and reacting it directly with a polysiloxane unit having a functional group reactive with the functional group, and methods of reacting it with a crosslinking agent such as diisocyanate.

Such polymers are also commercially available. An example thereof is Diaromer SP712 (trade name), manufactured by Dainichiseika Color & Chemicals Mfg. Co. Ltd.

In a more preferable structure, such a polymer has polyvinyl acetacetal as the polymer chain region.

In the present invention, a transferable protective layer laminate is preferably formed in area order onto the heat-sensitive transfer sheet. The transferable protective layer laminate is used for forming a protective layer composed of a transparent resin on a thermally transferred image by thermal transfer and thus covering and protecting the image, thereby to improve durability such as scratch resistance, light-fastness, and resistance to weather. This laminate is effective for a case where the transferred dye is insufficient in image durabilities such as light resistance, scratch resistance, and chemical resistance in the state that the dye is naked in the surface of an image-receiving sheet.

The transferable protective layer laminate can be formed by forming, onto a substrate, a releasing layer, a protective layer and an adhesive layer in this order (i.e., in the layer-described order) successively. The protective layer may be formed by plural layers. In the case where the protective layer also has functions of other layers, the releasing layer and the adhesive layer can be omitted. It is also possible to use a base film on which an easy adhesive layer has already been formed.

In the present invention, as a transferable protective layer-forming resin, preferred are resins that are excellent in scratch resistance, chemical resistance, transparency and hardness. Examples of the resin include polyester resins, acrylic resins, polystyrene resins, polyurethane resins, acrylic urethane resins, silicone-modified resins of the above-described resins, ultraviolet-shielding resins, mixtures of these resins, ionizing radiation-curable resins, and ultraviolet-curing resins. Particularly preferred are polyester resins and acrylic resins. These resins may be crosslinked with any one of various crosslinking agents.

In the heat-sensitive transfer sheet, it is preferred to dispose a back side layer on the surface (back side) of the substrate opposite to the thermal transfer layer coating side, namely on the same side as the surface with which a thermal head and the like contact. In addition, in the case of the protective layer transfer sheet, it is also preferred to dispose a back side layer on the surface (back side) of the substrate opposite to the transferable protective layer coating side, namely on the same side as the surface with which a thermal head and the like contact.

If the heat-sensitive transfer sheet is heated by a heating device such as a thermal head in the state such that the back side of the substrate of the transfer sheet directly contacts with the heating device, heat seal is apt to occur. In addition, owing to a large friction between them, it is difficult to smoothly transfer the heat-sensitive transfer sheet at the time of copying.

The back side layer is disposed so that the heat-sensitive transfer sheet enables to withstand heat energy from a thermal head. The back side layer prevents the heat seal, and enables a smooth travel action. In recent years, the necessity of the back side layer is becoming greater on account that the heat energy from a thermal head is increasing in association with speeding-up of the printer.

The back side layer is formed by coating a composition wherein additives such as a sliding agent, a release agent, a surfactant, inorganic particles, organic particles, and pigments are added to a binder. Further, an intermediate layer may be disposed between the back side layer and the substrate. As the intermediate layer, there has been known a layer containing inorganic fine particles and a water-soluble resin or a hydrophilic resin capable of emulsification.

A heat-sensitive transfer image-receiving sheet that can be used in the method of forming an image of the present invention will be described in detail hereinafter.

The heat-sensitive transfer image-receiving sheet has a support and at least one receptor layer containing a thermoplastic dye-receiving polymer formed thereon. The receptor layer may contain an ultraviolet absorbent, a releasing agent, a lubricant, an antioxidant, a preservative, a surfactant, and other additives. Between the support and the receptor layer may be formed an intermediate layer such as a heat insulating layer (porous layer), a gloss control layer, a white background adjusting layer, a charge control layer, an adhesive layer, or a primer layer. The heat-sensitive transfer image-receiving sheet preferably has at least one heat insulating layer between the support and the receptor layer.

The receptor layer and these intermediate layers are preferably formed by simultaneous multilayer coating, and a multiple number of these intermediate layers may be formed as needed.

A curling control layer, a writing layer, or a charge-control layer may be formed on the backside of the support. Each of these layers may be coated on the backside of the support by using a usual method such as a roll coating, a bar coating, a gravure coating, and a gravure reverse coating.

In the present invention, the heat-sensitive transfer image-receiving sheet contains a latex polymer having a glass transition temperature (Tg) of 20° C. or higher and 60° C. or lower in the receptor layer. The glass transition point of the latex polymer is preferably 25° C. or higher and 55° C. or lower, more preferably 25° C. or higher and 50° C. or lower.

In the present invention, use of a dyeable latex polymer is preferable. As a latex polymer, multiple latex polymeres may be used. In such a case, at least one latex polymer is necessary to have a glass transition temperature (Tg) in the range above. Most preferably, all latex polymeres contained have glass transition temperatures (Tgs) in the range above.

The latex polymer is generally a dispersion of fine particles of thermoplastic resin in a water-soluble dispersion medium. Examples of the thermoplastic resins used for the latex polymer according to the present invention include polycarbonates, polyesters, polyacrylates, vinyl chloride copolymers, polyurethane, styrene-acrylonitrile copolymers, polycaprolactone and the like.

Among them, polycarbonates, polyesters, and vinyl chloride copolymers are preferable, polyesters and vinyl chloride copolymer are particularly preferable, and vinyl chloride copolymer is most preferable.

The polyester is prepared by condensation of a dicarboxylic acid derivative and a diol compound, and may include an aromatic ring and/or a saturated carbon ring as well as a water-soluble group for imparting dispersibility thereto.

The vinyl chloride copolymer is a copolymer prepared with vinyl chloride as the polymerization monomer and other monomers, and examples thereof include vinyl chloride-vinyl acetate copolymers, vinyl chloride-acrylate copolymers, vinyl chloride-methacrylate copolymers, vinyl chloride-vinyl acetate-acrylate copolymers, and vinyl chloride-acrylate-ethylene copolymers. As described above, the copolymer may be a binary copolymer or a ternary or higher copolymer, and the monomers may be distributed randomly or uniformly by block copolymerization.

The copolymer may contain an auxiliary monomer component such as vinylalcohol derivatives, maleic acid derivatives, and vinyl ether derivatives. The copolymer preferably contain the vinyl chloride component in an amount of 50 mass % or more, and the auxiliary monomer component such as maleic acid derivative and vinyl ether derivative in an amount of 10 mass % or less.

The latex polymers may be used alone or as a mixture. The latex polymer may have a uniform structure or a core/shell structure, and in the latter case, the resins constituting the core and shell respectively may have different glass transition temperatures.

Examples of commercially available acrylate latexes include Nipol LX814 (Tg: 25° C.) and Nipol LX857X2 (Tg: 43° C.) (trade names, manufactured by ZEON CORPORATION) and others.

Examples of commercially available polyester latexes include VYLONAL MD-1100 (Tg: 40° C.), VYLONAL MD-1400 (Tg: 20° C.), VYLONAL MD-1480 (Tg: 20° C.) and VYLONAL MD-1985 (Tg: 20° C.) (trade names, manufactured by Toyobo Co. Ltd.) and others.

Examples of commercially available vinyl chloride copolymers include VINYBLAN 276 (Tg: 33° C.) and VINYBLAN 609 (Tg: 46° C.) (trade names, manufactured by Nissin Chemical Industry Co., Ltd.), Sumielite 1320 (Tg: 30° C.) and Sumielite 1210 (Tg: 20° C.) (trade names, manufactured by Sumika Chemtex Company, Limited) and others.

The addition amount of the latex polymers (latex polymer solid content) is preferably 50 to 98 mass %, more preferably 70 to 95 mass %, with respect to all polymers in the receptor layer. The average particle diameter of the latex polymers is preferably 1 to 50,000 nm, more preferably 5 to 1,000 nm.

In the present invention, the heat insulation layer preferably contains hollow polymer particles.

The hollow polymer particles in the present invention are polymer particles having voids inside of the particles. The hollow polymer particles are preferably aqueous dispersion. Examples of the hollow polymer particles include (1) non-foaming type hollow particles obtained in the following manner: a dispersion medium such as water is contained inside of a capsule wall formed of a polystyrene, acrylic resin, or styrene/acrylic resin, and, after a coating liquid is applied and dried, the water in the particles is vaporized out of the particles, with the result that the inside of each particle forms a hollow; (2) foaming type microballoons obtained in the following manner: a low-boiling-point liquid such as butane and pentane, is encapsulated in a resin constituted of any one of polyvinylidene chloride, polyacrylonitrile, polyacrylic acid, and polyacrylate, or their mixture or polymer, and after the resin coating material is applied, it is heated to expand the low-boiling-point liquid inside of the particles, whereby the inside of each particle is made to be hollow; and (3) microballoons obtained by foaming the above (2) under heating in advance, to make hollow polymer particles.

Of these, non-foaming hollow polymer particles of the foregoing (1) are preferred. If necessary, use can be made of a mixture of two or more kinds of polymer particles. Specific examples of the above (1) include Rohpake 1055, manufactured by Rohm and Haas Co.; Boncoat PP-1000, manufactured by Dainippon Ink and Chemicals, Incorporated; SX866(B), manufactured by JSR Corporation; and Nippol MH5055, manufactured by Nippon Zeon (all of these product names are trade names).

The average particle diameter (particle size) of the hollow polymer particles is preferably 0.1 to 5.0 μm, more preferably 0.2 to 3.0 μm, and particularly preferably 0.4 to 1.4 μm.

The hollow ratio (percentage of void) of the hollow polymer particles is preferably in the range of from about 20% to about 70%, and particularly preferably from 30% to 60%.

In the present invention, the particle size of the hollow polymer particle is calculated after measurement of the circle-equivalent diameter of the periphery of particle under a transmission electron microscope. The average particle diameter is determined by measuring the circle-equivalent diameter of the periphery of at least 300 hollow polymer particles observed under the transmission electron microscope and obtaining the average thereof.

The hollow ratio of the hollow polymer particles is calculated by the ratio of the volume of voids to the volume of a particle.

As for the resin properties of the hollow polymer particles for use in the heat-sensitive transfer image-receiving sheet in the present invention, the glass transition temperature (Tg) is preferably 70° C. or higher and 200° C. or lower, more preferably 90° C. or higher and 180° C. or lower. The hollow polymer particles are particularly preferably hollow latex polymer particles.

The heat-sensitive transfer image-receiving sheet, that can be used in the method of forming an image of the present invention, may contain a water-soluble polymer in the receptor layer and/or the heat insulation layer. Herein, “water-soluble polymer” means a polymer which dissolves, in 100 g water at 20° C., in an amount of preferably 0.05 g or more, more preferably 0.1 g or more, and still more preferably 0.5 g or more.

Specific examples of the water-soluble polymers which can be used in the heat-sensitive transfer image-receiving sheet of the present invention, include carrageenans, pectins, dextrins, gelatins, caseins, carboxymethylcelluloses, hydroxyethylcelluloses, hydroxypropylcelluloses, polyvinyl pyrrolidone, polyvinyl pyrrolidone copolymers, polyvinyl alcohol, polyethylene glycol, polypropylene glycol, and water-soluble polyesters. Among these, gelatin and polyvinyl alcohol are preferable.

Gelatin having a molecular weight of 10,000 to 1,000,000 may be used in the present invention. Gelatin that can be used in the present invention may contain an anion such as Cl⁻ and SO₄²⁻, or alternatively a cation such as Fe²⁺, Ca²⁺, Mg²⁺, Sn²⁺, and Zn²⁺. Gelatin is preferably added as an aqueous solution.

An ordinary crosslinking agent such as aldehyde-type crosslinking agent, N-methylol-type crosslinking agent, vinylsulfone-type crosslinking agent, or chlorotriazine-type crosslinking agent may be added to the gelatin above. Among the crosslinking agents above, vinylsulfone-type and chlorotriazine-type crosslinking agents are preferable, and typical examples thereof include bisvinylsulfonylmethylether, N,N′-ethylene-bis(vinylsulfonylacetamido)ethane, and 4,6-dichloro-2-hydroxy-1,3,5-triazine or the sodium salt thereof.

As the polyvinyl alcohol, there can be used various kinds of polyvinyl alcohols such as complete saponification products thereof, partial saponification products thereof, and modified polyvinyl alcohols. With respect to these polyvinyl alcohols, those described in Koichi Nagano, et al., “Poval”, Kobunshi Kankokai, Inc. are useful.

The viscosity of polyvinyl alcohol can be adjusted or stabilized by adding a trace amount of a solvent or an inorganic salt to an aqueous solution of polyvinyl alcohol, and use may be made of compounds described in the aforementioned reference “Poval”, Koichi Nagano et al., published by Kobunshi Kankokai, pp. 144-154. For example, a coated-surface quality can be improved by an addition of boric acid, and the addition of boric acid is preferable. The amount of boric acid to be added is preferably 0.01 to 40 mass %, with respect to polyvinyl alcohol.

Specific examples of the polyvinyl alcohols include completely saponificated polyvinyl alcohol such as PVA-105, PVA-110, PVA-117 and PVA-117H (trade names, manufactured by KURARAY CO., LTD.); partially saponificated polyvinyl alcohol such as PVA-203, PVA-205, PVA-210 and PVA-220 (trade names, manufactured by KURARAY CO., LTD.); and modified polyvinyl alcohols such as C-118, HL-12E, KL-118 and MP-203 (trade names, manufactured by KURARAY CO., LTD.).

In the present invention, the receptor layer of the heat-sensitive transfer image-receiving sheet may contain the polymer compound having fluorine atom-substituted aliphatic groups on its side chains described above. In such a case, it may contain a polymer compound identical with or different in kind from the polymer compound having fluorine atom-substituted aliphatic groups on its side chains contained in the heat-sensitive transfer sheet, and both cases are preferable embodiments of the present invention. It may also contain, as a releasing agent, an ordinary polyethylene wax, a solid wax such as amide wax, a silicone oil, a phosphate ester compound, a fluorine-containing surfactant or a silicone-based surfactant.

The content of the polymer compound having fluorine atom-substituted aliphatic groups on its side chains is 0.01% to 20%, preferably 0.1% to 10% and more preferably 1% to 5%, with respect to the total solid content (mass) in the receptor layer.

In the image-forming method (system) of the present invention, imaging is achieved by superposing a heat-sensitive transfer sheet on a heat-sensitive transfer image-receiving sheet so that a heat transfer layer of the heat-sensitive transfer sheet is in contact with a receptor layer of the heat-sensitive transfer image-receiving sheet and giving thermal energy in accordance with image signals given from a thermal head.

Specifically, image-forming can be achieved by the similar manner to that as described in, for example, JP-A-2005-88545. In the present invention, a printing time is preferably less than 15 seconds, and more preferably in the range of 3 to 12 seconds, and further preferably 3 to 7 seconds, from the viewpoint of shortening a time taken until a consumer gets a print.

In order to accomplish the above-described printing time, a line speed at the time of printing is preferably 0.73 msec/line or less, and further preferably 0.65 msec/line or less. Further, from the viewpoint of improvement in transfer efficiency as one of speeding-up conditions, the maximum ultimate temperature of the thermal head at the time of printing is preferably in the range of from 180° C. to 450° C., more preferably from 200° C. to 450° C., and furthermore preferably from 350° C. to 450° C.

The method of the present invention may be utilized for printers, copying machines and the like, which employs a heat-sensitive transfer recording system. As a means for providing heat energy in the thermal transfer, any of the conventionally known providing means may be used. For example, application of a heat energy of about 5 to 100 mJ/mm² by controlling recording time in a recording device such as a thermal printer (e.g. trade name: Video Printer VY-100, manufactured by Hitachi, Ltd.), sufficiently attains the expected result. Also, the heat-sensitive transfer image-receiving sheet for use in the present invention may be used in various applications enabling thermal transfer recording, such as heat-sensitive transfer image-receiving sheets in a form of thin sheets (cut sheets) or rolls; cards; and transmittable type manuscript-making sheets, by optionally selecting the type of support.

The present invention can provide an image-forming method giving an image superior in storability that is resistant to fusion due to separation defects and imaging troubles on the printing face after separation, even in fluctuation in environmental conditions, especially under high-temperature high-humidity conditions.

### EXAMPLES

The present invention will be described in more detail based on the following examples, but the invention is not intended to be limited thereto. In the following examples, the terms “part(s)” and “%” are values by mass, unless otherwise specified.

### Example 1

### (Production of Heat-Sensitive Transfer Sheets)

Heat-sensitive transfer sheet sample 101 was prepared as follows.

A polyester film 4.5 μm in thickness (trade name: Lumirror 5A-F595, manufactured by TORAY INDUSTRIES, INC), that was subjected to an easy-adhesion-treatment on one surface of the film, was used as a support. The following back side-layer coating liquid was applied onto the support on the other surface that was not subjected to the easy-adhesion-treatment, so that the coating amount based on the solid content after drying would be 1 g/m². After drying, the coating liquid was cured by heat at 50° C.

Coating liquids, which will be detailed later, were used to form, onto the easily-adhesive layer painted surface of the thus-formed polyester film, individual heat-sensitive transfer layers in yellow, magenta and cyan, and a transferable protective layer laminate in area order by painting. In this way, a heat-sensitive transfer sheet was produced. The solid coating amount in each of the heat-sensitive transfer layers (dye layers) was set to 0.8 g/m².

In the formation of the transferable protective layer laminate, a releasing-liquid-coating liquid was painted, a protective-layer-coating liquid was painted thereon, the resultant was dried, and then an adhesive-layer-coating liquid was painted thereon.

| Back side layer-coating liquid | | |
|---|---|---|
| Acrylic polyol resin | 17.3 | mass parts |
| (trade name: ACRYDIC A-801, manufactured by Dainippon Ink and Chemicals, | | |
| Incorporated) | | |
| Zinc stearate | 0.26 | mass part |
| (trade name: SZ-2000, manufactured by Sakai Chemical Industry Co., Ltd.) | | |
| Phosphate ester | 0.52 | mass parts |
| (trade name: Phoslex A18, manufactured by Sakai Chemical Industry Co., Ltd.) | | |
| Phosphate ester | 3.59 | mass parts |
| (trade name: PLYSURF A217, manufactured by Dai-ichi Kogyo Seiyaku Co., Ltd.) | | |
| Talc | 0.52 | mass parts |
| (trade name: MICRO ACE L-1, manufactured by NIPPON TALC Co., Ltd.) | | |
| Magnesium oxide | 0.07 | mass parts |
| (trade name: STARMAG PSF, manufactured by Konoshima Chemical Co., Ltd.) | | |
| Polyisocyanate | 7.77 | mass parts |
| (trade name: BURNOCK D-800, manufactured by Dainippon Ink and Chemicals, | | |
| Incorporated) | | |
| Methyl ethyl ketone/Toluene (2/1, at mass ratio) | 70 | mass parts |
| Yellow-dye-layer-coating liquid | | |
| Dye (Y-1) | 1.1 | mass parts |
| Dye (Y-2) | 0.3 | mass parts |
| Dye (Y-3) | 4.0 | mass parts |
| Dye (Y-4) | 1.9 | mass parts |
| Polyvinylacetal resin (Tg = 110° C.) | 7.5 | mass parts |
| (trade name: DENKA BUTYRAL #5000-D, manufactured by DENKI KAGAKU | | |
| KOGYOU K.K.) | | |
| Fluorine-containing polymer compound | 0.1 | mass parts |
| (trade name: Megafac F-472SF, manufactured by Dainippon Ink & | | |
| Chemicals Incorporated) | | |
| Matting agent | 0.12 | mass part |
| (trade name: Flo-thene UF, manufactured by Sumitomo Seika Chemicals Co., Ltd.) | | |
| Methyl ethyl ketone/Toluene (2/1, at mass ratio) | 85 | mass parts |
| Magenta-dye-layer-coating liquid | | |
| Dye (M-1) | 0.5 | mass part |
| Dye (M-2) | 0.5 | mass part |
| Dye (M-3) | 6.3 | mass parts |
| Polyvinylacetal resin (Tg = 110° C.) | 7.5 | mass parts |
| (trade name: DENKA BUTYRAL #5000-D, manufactured by DENKI KAGAKU | | |
| KOGYOU K.K.) | | |
| Fluorine-containing polymer compound | 0.1 | mass parts |
| (trade name: Megafac F-472SF, manufactured by Dainippon Ink & | | |
| Chemicals Incorporated) | | |
| Matting agent | 0.12 | mass part |
| (trade name: Flo-thene UF, manufactured by Sumitomo Seika Chemicals Co., Ltd.) | | |
| Methyl ethyl ketone/Toluene (2/1, at mass ratio) | 85 | mass parts |
| Cyan-dye-layer-coating liquid | | |
| Dye (C-1) | 0.1 | mass part |
| Dye (C-2) | 6.8 | mass parts |
| Dye (C-3) | 0.4 | mass parts |
| Polyvinylacetal resin (Tg = 110° C.) | 7.5 | mass parts |
| (trade name: DENKA BUTYRAL #5000-D, manufactured by DENKI KAGAKU | | |
| KOGYOU K.K.) | | |
| Fluorine-containing polymer compound | 0.1 | mass parts |
| (trade name: Megafac F-472SF, manufactured by Dainippon Ink & | | |
| Chemicals Incorporated) | | |
| Matting agent | 0.12 | mass part |
| (trade name: Flo-thene UF, manufactured by Sumitomo Seika Chemicals Co., Ltd.) | | |
| Methyl ethyl ketone/Toluene (2/1, at mass ratio) | 85 | mass parts |
| Y-1 | | |
| 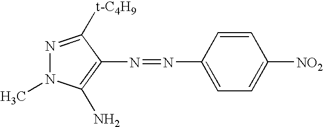 | | |
| Y-2 | | |
| 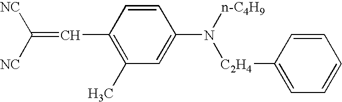 | | |
| Y-3 | | |
| 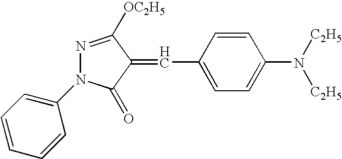 | | |
| Y-4 | | |
| 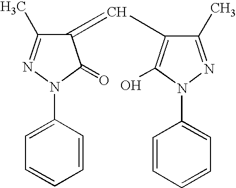 | | |
| M-1 | | |
| 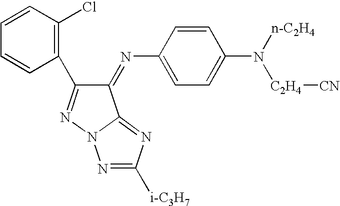 | | |
| M-2 | | |
| 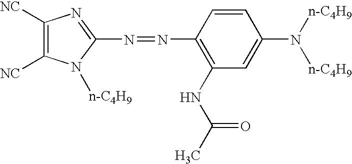 | | |
| M-3 | | |
| 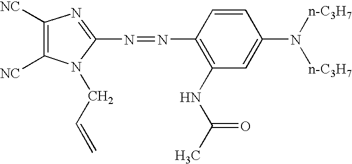 | | |
| C-1 | | |
| 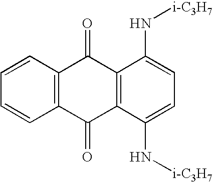 | | |
| C-2 | | |
| 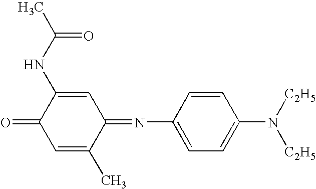 | | |
| C-3 | | |
| 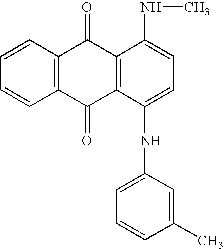 | | |

### (Transfer Protective Layer Laminate)

On the polyester film coated with the dye layers as described above, coating solutions of a releasing layer, a protective layer and an adhesive layer each having the following composition was coated, to form a transfer protective layer laminate. Coating amounts of the releasing layer, the protective layer and the adhesive layer after drying were 0.5 g/m², 1.0 g/m² and 1.8 g/m², respectively.

| Releasing-layer-coating liquid | | |
|---|---|---|
| Modified cellulose resin | 5.0 | mass parts |
| (trade name: L-30, manufactured by DAICEL CHEMICAL INDUSTRIES, LTD.) | | |
| Methyl ethyl ketone | 95.0 | mass parts |
| Protective-layer-coating liquid | | |
| Acrylic resin | 35 | mass parts |
| (trade name: DIANAL BR-100, manufactured by MITSUBISHI RAYON CO., | | |
| LTD.) | | |
| Isopropanol | 75 | mass parts |
| Adhesive-layer-coating liquid | | |
| Acrylic resin | 25 | mass parts |
| (trade name: DIANAL BR-77, manufactured by MITSUBISHI RAYON CO., LTD.) | | |
| The following ultraviolet absorber UV-l | 1.5 | mass parts |
| The following ultraviolet absorber UV-2 | 1.5 | mass parts |
| The following ultraviolet absorber UV-3 | 1.2 | mass parts |
| The following ultraviolet absorber UV-4 | 0.8 | mass part |
| Silicone-based resin fine particles | 0.06 | mass part |
| (trade name: TOSPEARL 120, manufactured by MOMENTIVE Performance | | |
| Materials Japan LLC.) | | |
| Methyl ethyl ketone/toluene (2/1, at mass ratio) | 70 | mass parts |
| (UV-1) | | |
| 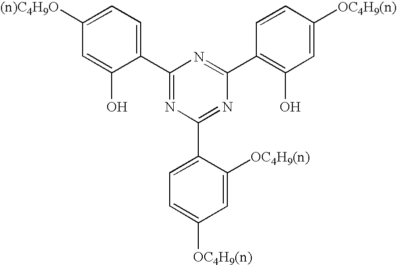 | | |
| (UV-2) | | |
| 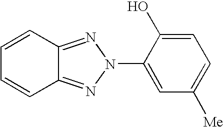 | | |
| (UV-3) | | |
| 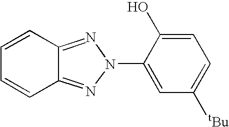 | | |
| (UV-4) | | |
| 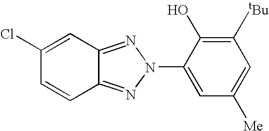 | | |

Samples 102 to 113 were prepared in the same manner as in sample 101, except that the kind of the binder, the fluorine compound, the silicone compound and the addition amount of the binder were changed to thereby vary the dye/binder ratio, as shown in Table 1. When the silicone compound is added to sample 101, it is added in an amount equivalent to 0.1 mass parts in the original composition.

TABLE 1

| | Kind of | Fluorine | Dye/binder | | |
|---|---|---|---|---|---|
| Sample | binder | compound | ratio | Silicone compound | Remarks |
| 101 | B-1 | F-1 | 0.97 | None | This |
| | | | | | invention |
| 102 | B-1 | F-1 | 1.21 | None | This |
| | | | | | invention |
| 103 | B-1 | F-1 | 1.21 | Diaromer SP-712, trade | This |
| | | | | name, manufactured by | invention |
| | | | | Dainichiseika Color & | |
| | | | | Chemicals Mfg. Co., Ltd. | |
| | | | | (Graft-type or block-type) | |
| 104 | B-2 | F-1 | 0.97 | None | Comparative |
| | | | | | example |
| 105 | B-2 | F-1 | 1.21 | None | Comparative |
| | | | | | example |
| 106 | B-2 | F-1 | 1.21 | Diaromer SP-712, trade | Comparative |
| | | | | name, manufactured by | example |
| | | | | Dainichiseika Color & | |
| | | | | Chemicals Mfg. Co., Ltd. | |
| 107 | B-1 | None | 0.97 | None | Comparative |
| | | | | | example |
| 108 | B-1 | F-2 | 0.97 | None | This |
| | | | | | invention |
| 109 | B-1 | F-3 | 0.97 | None | This |
| | | | | | invention |
| 110 | B-1 | F-4 | 0.97 | None | Comparative |
| | | | | | example |
| 111 | B-1 | F-1 | 0.97 | Diaromer SP-712, trade | This |
| | | | | name, manufactured by | invention |
| | | | | Dainichiseika Color & | |
| | | | | Chemicals Mfg. Co., Ltd. | |
| | | | | (Graft-type or block-type) | |
| 112 | B-3 | F-1 | 1.21 | Diaromer SP-712, trade | This |
| | | | | name, manufactured by | invention |
| | | | | Dainichiseika Color & | |
| | | | | Chemicals Mfg. Co., Ltd. | |
| | | | | (Graft-type or block-type) | |
| 113 | B-3 | None | 1.21 | Diaromer SP-712, trade | Comparative |
| | | | | name, manufactured by | example |
| | | | | Dainichiseika Color & | |
| | | | | Chemicals Mfg. Co., Ltd. | |
| | | | | (Graft-type or block-type) | |

TABLE 2
Kind of binder

| | | | Content of | Acetacetal |
|---|---|---|---|---|
| Sam- | | Tg | acetal unit | rate |
| ple | Name | (° C.) | (mass %) | (mass %) |
| B-1 | Trade name: DENKA BUTYRAL | 110 | 81 | 100 |
| | #5000-D, manufactured by DENKI | | | |
| | KAGAKU KOGYOU K. K. | | | |
| B-2 | Trade name: DENKA BUTYRAL | 95 | 87 | 70 |
| | #6000-CS, manufactured by | | | |
| | DENKI KAGAKU | | | |
| | KOGYOU K. K. | | | |
| B-3 | Trade name: DENKA BUTYRAL | 110 | 87 | 100 |
| | #6000-AS, manufactured by | | | |
| | DENKI KAGAKU | | | |
| | KOGYOU K. K. | | | |

TABLE 3
Fluorine compound

| Sample | Additive | Classification of compound |
|---|---|---|
| F-1 | Megafac F-472SF, trade | Polymer compound having |
| | name, manufactured by | fluorine atom-substituted |
| | Dainippon Ink and | aliphatic groups on its side |
| | Chemicals, Inc. | chains, nonionic, water-soluble |
| F-2 | Megafac F-479, trade name, | Polymer compound having |
| | manufactured by Dainippon | fluorine atom-substituted |
| | Ink and Chemicals, Inc. | aliphatic groups on its |
| | | side chains, nonionic, |
| | | water-soluble |
| F-3 | Megafac F-483, trade name, | Polymer compound having |
| | manufactured by Dainippon | fluorine atom-substituted |
| | Ink and Chemicals, Inc. | aliphatic groups on its side |
| | | chains, nonionic, water-insoluble |
| F-4 | Zonyl FSA, trade name, | Lithium salt of fluorocarboxylic |
| | manufactured by Du Pont Co. | acid, anionic, water-soluble |

### (Preparation of Heat-Sensitive Transfer Image-Receiving Sheet (Z-1))

A paper support, on both sides of which polyethylene was laminated, was subjected to corona discharge treatment on the surface thereof, and then a gelatin undercoat layer containing sodium dodecylbenzenesulfonate was disposed on the treated surface. The subbing layer, the heat insulation layer, the lower receptor layer and the upper receptor layer each having the following composition were multilayer-coated on the gelatin undercoat layer, in the state that the subbing layer, the heat insulation layer, the lower receptor layer and the upper receptor layer were laminated in this order from the side of the support, by a method illustrated in FIG. 9 in U.S. Pat. No. 2,761,791. The coating was performed so that coating amounts of the subbing layer, the heat insulation layer, the lower receptor layer and the upper receptor layer after drying would be 6.0 g/m², 8.5 g/m², 2.4 g/m² and 3.0 g/m², respectively. The resulting composite was dried and then heat-treated at 30° C. for 5 days, subjected to crosslinking reaction with a crosslinking agent and gelatin, and processed into a shape suitable for the settings of the printer, to give Heat-sensitive transfer image-receiving sheet (Z-1).

| Upper receptor-layer coating-liquid | | |
|---|---|---|
| Vinyl chloride-based latex (Tg = 70° C.) | 21.0 | mass parts |
| (trade name: Vinybran 900, manufactured by Nisshin Chemicals Co., Ltd.) | | |
| Vinyl chloride-based latex (Tg = 33° C.) | 1.6 | mass parts |
| (trade name: Vinybran 276, manufactured by Nisshin Chemicals Co., Ltd.) | | |
| Gelatin (10% solution) | 2.5 | mass parts |
| The ester-based wax EW-1 | 1.8 | mass parts |
| Surfactant 1 | 0.1 | mass part |
| Surfactant 2 | 0.4 | mass part |
| Lower receptor-layer coating-liquid | | |
| Vinyl chloride-based latex (Tg = 46° C.) | 18.0 | mass parts |
| (trade name: Vinybran 690, manufactured by Nisshin Chemicals Co., Ltd.) | | |
| Vinyl chloride-based latex (Tg = 70° C.) | 8.0 | mass parts |
| (trade name: Vinybran 900, manufactured by Nisshin Chemicals Co., Ltd.) | | |
| Gelatin (10% solution) | 8.0 | mass parts |
| Surfactant 1 | 0.03 | mass part |
| Heat insulation layer-coating liquid | | |
| Acrylic styrene based hollow polymer particles | 66.0 | mass parts |
| (average particle size 0.5 μm) | | |
| (trade name: MH5055, manufactured by Nippon Zeon Co., Ltd.) | | |
| Gelatin (10% solution) | 24.0 | mass parts |
| Sodium salt of 4,6-dichloro-2-hydroxy- 1,3,5-triazine | 0.1 | mass part |
| (Crosslinking agent) | | |
| Intermediate layer-coating liquid 1 | | |
| Polyvinyl alcohol | 7.0 | mass parts |
| (POVAL PVA205: trade name, manufactured by Kuraray) | | |
| Styrene/butadiene based latex | 55.0 | mass parts |
| (SN-307; trade name, manufactured by Nippon A&L Inc) | | |
| Surfactant 1 | 0.02 | mass part |
| (EW-1) | | |
| 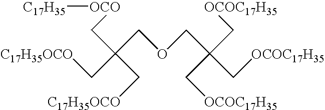 | | |
| Surfactant 1 | | |
| 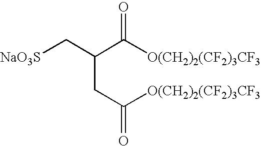 | | |
| Surfactant 2 | | |
| 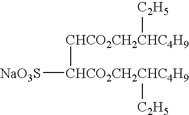 | | |

### (Preparation of Heat-Transfer Image-Receiving Sheet (Z-2))

A synthetic paper (trade name: Yupo FPG 200, manufactured by Yupo Corporation, thickness: 200 μm) was used as the support; and, on one surface of the support, a white intermediate layer and a receptor layer, having the following compositions, were coated in this order by a bar coater. The coating was carried out such that the amount of the white intermediate layer and the amount of the receptor layer after each layer was dried would be 1.0 g/m² and 4.0 g/m², respectively, and the resulting film was dried after coating, processed into a shape suitable for the settings of the printer, to give a heat-sensitive transfer image-receiving sheet (Z-2).

White intermediate layer

| | | |
|---|---|---|
| Polyester resin (Tg = 67° C.) | 10 | mass parts |
| (Trade name: Vylon 200, manufactured by Toyobo | | |
| Co., Ltd.) | | |
| Fluorescent whitening agent | 1 | mass part |
| (Trade name: Uvitex OB, manufactured by Ciba-Geigy) | | |
| Titanium oxide | 30 | mass parts |
| Methyl ethyl ketone/toluene (1/1, at mass ratio) | 90 | mass parts |

### Composition of Receptor Layer-Coating Liquid:

| | |
|---|---|
| Vinyl chloride/vinyl acetate copolymer (Tg = 76° C.) | 100 mass parts |
| (Trade name: Solbin A, manufactured by Nisshin | |
| Chemicals Co., Ltd.) | |
| Amino-modified silicone | 5 mass parts |
| (X22-3050C, tradename, manufactured by Shin-Etsu | |
| Chemical Co., Ltd.) | |
| Epoxy-modified silicone | 5 mass parts |
| (X22-3000E, tradename, manufactured by Shin-Etsu | |
| Chemical Co., Ltd.) | |
| Methyl ethyl ketone/toluene (1/1, at mass ratio) | 400 mass parts |

### (Evaluation)

Printing characteristics, when the heat-sensitive transfer sheet and the heat-sensitive transfer image-receiving sheet were used in combination, were evaluated under different storage/printing environmental conditions. Fujifilm thermal photoprinter ASK-2000L (trade name, manufactured by FUJIFILM CORPORATION) was used as a printer for the evaluation of image-forming methods.

Samples were left under the following environmental conditions; an image of 127 mm×89 mm in size was output continuously on ten sheets under the same conditions; the separation residue, fusion or white spots of the output image were evaluated according to the following criteria. Two images of each of a person (wedding ceremony (in wedding dress)), a person (indoor), a person (outdoor), and a solid black image, were evaluated under the following environmental conditions A and B for storage and printing by ten viewers by organoleptic evaluation, and the average value of the criteria was determined.

### Environmental Conditions for Storage and Printing

A. The heat-sensitive transfer sheet above after preparation was stored under the environment at a temperature of 25° C. and a humidity of 55% for 5 days, and the heat-sensitive transfer sheet, the heat-sensitive transfer image-receiving sheet, and the printer after storage were stored under the environment at a temperature of 25° C. and a humidity of 55% for 24 hours, and printing was carried out under the same conditions.

B. The heat-sensitive transfer sheet above after preparation was stored under the environment at a temperature of 25° C. and a humidity of 55% for 5 days, and the heat-sensitive transfer sheet, the heat-sensitive transfer image-receiving sheet, and the printer after storage were stored under the environment at a temperature of 35° C. and a humidity of 80% for 24 hours, and printing was carried out under the same conditions.

C. The heat-sensitive transfer sheet above after preparation was stored under the environment at a temperature of 50° C. and a humidity of 60% for 5 days, and the heat-sensitive transfer sheet, the heat-sensitive transfer image-receiving sheet, and the printer after storage were stored under the environment at a temperature of 35° C. and a humidity of 80% for 24 hours, and printing was carried out under the same conditions.

### (1) Evaluation Criteria of Color Contamination (Color Stain)

5: No color stain observed in a white area.

4: Slight color stain observed in the white area, when compared with the unprinted heat-sensitive transfer image-receiving paper, but only to the extent without any deterioration in image appearance.

3: Some color stain observed in the white area, but without significant deterioration in image appearance.

2: Significant color stain observed in the white area, leading to deterioration in image appearance.

1: Significant color stain observed in the white area and loss of images in the low density region.

### (2) Evaluation Criteria of Separation Residue and Fusion

5: No separation residue was detected by visual observation.

4: Some separation residue was detected but only to the degree allowing appreciation of image without difficulty.

3: Separation residue prohibited appreciation of image, depending on the kind of image.

2: Separation residue prohibited appreciation of image observed regardless of the kind of image.

1: Fusion of heat-sensitive transfer sheet and heat-sensitive transfer image-receiving sheet was observed.

### (Evaluation Result)

TABLE 4

| | | | Conditions A for storage and | | Conditions B for storage and | | |
|---|---|---|---|---|---|---|---|
| | Sample | | printing | | printing | | |
| | | Heat-sensitive | | Evaluation of | | Evaluation | |
| | Heat-sensitive | transfer image- | Evaluation of | fusion after | Evaluation of | of fusion | |
| Experimental No. | transfer sheet No. | receiving sheet No. | color stain | separation | color stain | after separation | Remarks |
| 1 | 101 | Z-1 | 5.0 | 4.8 | 4.2 | 4.3 | This invention |
| 2 | 102 | Z-1 | 5.0 | 4.8 | 4.1 | 4.3 | This invention |
| 3 | 103 | Z-1 | 5.0 | 5.0 | 4.8 | 4.8 | This invention |
| 4 | 104 | Z-1 | 5.0 | 5.0 | 3.3 | 4.2 | Comparative example |
| 5 | 105 | Z-1 | 4.9 | 4.6 | 2.6 | 4.0 | Comparative example |
| 6 | 106 | Z-1 | 5.0 | 5.0 | 2.1 | 4.6 | Comparative example |
| 7 | 107 | Z-1 | 5.0 | 4.6 | 4.8 | 2.5 | Comparative example |
| 8 | 108 | Z-1 | 4.9 | 5.0 | 4.5 | 4.7 | This invention |
| 9 | 109 | Z-1 | 4.8 | 5.0 | 4.7 | 4.4 | This invention |
| 10 | 110 | Z-1 | 5.0 | 5.0 | 2.8 | 2.7 | Comparative example |
| 11 | 111 | Z-1 | 4.9 | 5.0 | 4.0 | 4.8 | This invention |
| 12 | 101 | Z-2 | 5.0 | 5.0 | 3.6 | 4.8 | Comparative example |
| 13 | 102 | Z-2 | 4.9 | 5.0 | 3.1 | 5.0 | Comparative example |
| 14 | 103 | Z-2 | 4.8 | 5.0 | 2.9 | 5.0 | Comparative example |
| 15 | 104 | Z-2 | 5.0 | 5.0 | 2.9 | 4.6 | Comparative example |
| 16 | 105 | Z-2 | 5.0 | 5.0 | 2.6 | 4.4 | Comparative example |
| 17 | 106 | Z-2 | 4.7 | 5.0 | 2.5 | 4.8 | Comparative example |
| 18 | 107 | Z-2 | 5.0 | 5.0 | 3.9 | 3.9 | Comparative example |
| 19 | 112 | Z-1 | 5.0 | 5.0 | 4.8 | 4.7 | This invention |
| 20 | 113 | Z-1 | 4.8 | 4.8 | 4.7 | 3.2 | Comparative example |

As is apparent from Table 4, the image-forming methods in combination of the heat-sensitive transfer sheet and the heat-sensitive transfer image-receiving sheet according to the present invention are fewer separation residues, fusions and stains in white area than those in the Comparative examples and the preferable properties are retained even after the heat-sensitive transfer sheet is stored.

### Example 2

Heat-sensitive transfer sheets 201 to 206 were prepared by adding, to the heat-sensitive transfer sheets 101 to 106 prepared in Example 1, a crosslinking hardening agent (Takenate D110N, trade name, manufactured by Mitsui Chemicals Polyurethanes Inc.) in an amount of 18 mass % with respect to the binder. The heat-sensitive transfer sheets prepared were stored after preparation in an environment at 50° C. for 24 hours for acceleration of crosslinking reaction.

Printing characteristics in combination of these samples and the heat-sensitive transfer image-receiving sheet Z-1 prepared in Example 1 were also evaluated under the above-mentioned environmental conditions C for storage and printing in the same manner as in Example 1. Results are summarized in Table 5.

### (Evaluation Result)

TABLE 5

| | | | Conditions C for storage | | |
|---|---|---|---|---|---|
| | Sample | | and printing | | |
| | Heat-sensitive | Heat-sensitive | Evaluation | Evaluation of | |
| Experimental | transfer sheet | transfer image- | of color | fusion after | |
| No. | No. | receiving sheet No. | stain | separation | Remarks |
| 21 | 201 | Z-1 | 4.2 | 4.2 | This |
| | | | | | invention |
| 22 | 202 | Z-1 | 4.3 | 4.4 | This |
| | | | | | invention |
| 23 | 203 | Z-1 | 4.9 | 4.8 | This |
| | | | | | invention |
| 24 | 204 | Z-1 | 2.5 | 4.1 | Comparative |
| | | | | | example |
| 25 | 205 | Z-1 | 1.9 | 4.4 | Comparative |
| | | | | | example |
| 26 | 206 | Z-1 | 2.1 | 4.5 | Comparative |
| | | | | | example |

As is apparent from Table 5, the image-forming methods in combination of the heat-sensitive transfer sheet and the heat-sensitive transfer image-receiving sheet according to the present invention are more fewer separation residues, fusions and stains in white area than those in the Comparative examples even when a crosslinking hardening agent is added to the heat-sensitive transfer sheet, and use of the crosslinking hardening agent is effective in improving the storage characteristics of the heat-sensitive transfer sheet.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. § 119 (a) on Patent Application No. 2008-032447 filed in Japan on Feb. 13, 2008, which is entirely herein incorporated by reference.

What we claim is:

1. A method of forming an image, comprising the steps of:
superposing a heat-sensitive transfer sheet on a heat-sensitive transfer image-receiving sheet, and
applying thermal energy from a side of a heat-resistant lubricating layer described below of the heat-sensitive transfer sheet, to transfer a thermally transferable dye in a thermal transfer layer to a receptor layer described below, thereby forming a thermally transferred image,
wherein the heat-sensitive transfer sheet comprises a substrate, the thermal transfer layer containing the thermally transferable dye and a resin on one face of the substrate, and the heat-resistant lubricating layer on the other face of the substrate,
wherein the heat-sensitive transfer image-receiving sheet comprise a support, and at least one heat insulation layer and at least one receptor layer on the support in this order,
wherein the dye in the thermal transfer layer is present in an oil soluble resin having a glass transition temperature (Tg) of 98° C. or more as it is dispersed in the resin,
wherein the thermal transfer layer contains a polymer compound having fluorine atom-substituted aliphatic groups on its side chains, and
wherein the receptor layer of the heat-sensitive transfer image-receiving sheet contains a latex and a water-soluble polymer compound.

2. The method of forming an image according to claim 1, wherein the resin in the thermal transfer layer is a polyvinylacetal resin containing acetal units in an amount of 80 mass % or more in the resin and the acetacetal rate is 90 mass % or more in the acetal unit.

3. The method of forming an image according to claim 1, comprising: using a heat-sensitive transfer sheet, wherein the ratio of the dye in the thermal transfer layer is 1 or more by weight in the resin.

4. The method of forming an image according to claim 1, wherein the heat-sensitive transfer sheet contains at least one compound selected from the silicone graft polymers and silicone block polymers.

5. The method of forming an image according to claim 1, wherein the resin in the thermal transfer layer is hardened with a crosslinking agent.
